(19) United States
(12) Patent Application Publication
(10) Pub. No.: US 2001/0037325 A1
(43) Pub. Date: Nov. 1, 2001

(54) Method and system for locating internet users having similar navigation patterns

(76) Inventors: Alexis Biderman, Paris (FR); Ilan Azouri, Hertzlia (IL)

Correspondence Address: BROWDY AND NEIMARK, P.L.L.C., 624 Ninth Street, N.W., Washington, DC, 20001-5303, US

(21) Appl. No.: 09/796,730

(22) Filed: Mar. 2, 2001

(30) Foreign Application Priority Data
Mar. 6, 2000 (IL) 134893

(51) Int. Cl. G06F 7/00

(52) U.S. Cl. 707/1

(57) ABSTRACT

A computer implemented method and system for allowing a first web surfer to locate at least one second web surfer having similar navigation and/or search strategies, wherein a web server in communication with the first and at least one second web surfers receives key words and/or URLs derived by parsing respective navigation strings from all web surfers in communication with the web server. This permits extraction of respective URLs of web sites visited by the web surfers and/or keywords indicative of a navigation string. The web server compiles a database of these keywords and URLs including a URL of each respective web surfer, and cross-references the database for similar keywords and/or URLs to those of the first web surfer so as to locate at least one second web surfer having a similar navigation pattern or search strategy.

### FIELD OF THE INVENTION

This invention relates to a search engine for the Internet.

### BACKGROUND OF THE INVENTION

The Internet is a vast amorphous expanse of knowledge accessed daily by millions of users, each one of whom surfs the Web in an effective vacuum unaware that amongst the teeming millions of other users there may, and very likely do, exist one or more like-minded people. There could be great benefit in locating such like-minded users since it might lead to collaborative ventures, useful trade contacts and even valuable friendships. However, there is currently little that is being done in this regard, owing to the highly distributed nature of the Internet and the fact that the Internet comprises a large number of spatially separate servers, none of which maintains a complete picture of Internet usage.

Database searching per se based on keywords in order to locate matching text strings is well established. Likewise, it is known to search databases for similarities to a given subject, be it graphical or textual. U.S. Pat. No. 5,793,964 assigned to International Business Machines Corporation discloses a Web browser system comprising:

means for associating a web browser with a homepage by a coupling or addressing with a uniform resource locator (URL or UAL),

a control program agent node located somewhere on the Internet supporting a control program agent coupled to and supporting said homepage by a coupling or addressing with a uniform resource locator,

said control program agent node being coupled via a network with facilities provided within an intranet for private owner facilities and which may be protected by firewalls at the intranet boundary,

said control program agent being coupled to a command file server and said command file server being coupled to a database gateway for gathering information from databases coupled to said database gateway and located on different database servers, said command file server supporting a plurality of command file objects which are programmed to perform web browser service support functions at the request of a user of said web browser to access information within the intranet and to gather information located elsewhere via the Internet as a sub-agent of said control program agent.

Such a system thus allows distributed databases on the Internet to be accessed for collecting information from various sources corresponding to a client's query.

U.S. Pat. No. 5,796,393 (MacNaughton et al) and assigned to CompuServe Inc. discloses a system and method for integrating an on-line service community with a foreign service such as the Internet World Wide Web. Such a system requires that on-line service subscribers access a membership module to complete a membership process in which they join communities each of which represents a specific area of interest. The system operates as an extension to a user's preferred Web browser and is manifested as a toolbar comprised of control buttons and a viewer on a computer user's screen. By interacting with the control buttons of the toolbar and the menus of the viewer, on-line service content is delivered to the user in response to the URLs specified by the user as he or she browses the Web. In addition, control buttons on the toolbar present opportunities for interacting with other community members. Web surfers benefiting from such a system must belong to the same community and the method and system are not expandable to disassociated users.

U.S. Pat. No. 5,864,863 (Burrows) and assigned to Digital Equipment Corporation discloses a method for parsing, indexing and searching world-wide-web pages. Such a system indexes Web pages of the Internet. The pages are stored in computers distributively connected to each other by a communications network. Each page has a unique URL (universal record locator). Some of the pages can include URL links to other pages. A communication interface connected to the Internet is used for fetching a batch of Web pages from the computers in accordance with the URLs and URL links. An automated Web browser connected to the communications interface determines the URLs. A parser sequentially partitions the batch of specified pages into indexable words where each word represents an indexable portion of information of a specific page, or the word represents an attribute of one or more portions of the specific page. The parser sequentially assigns locations to the words as they are parsed. The locations indicate the unique occurrences of the word in the Web. The output of the parser is stored in a memory as an index. The index includes one index entry for each unique word. Each index entry also includes one or more location entries indicating where the unique word occurs in the Web. A query module parses a query into terms and operators. The operators relate the terms. A search engine uses object-oriented stream readers to sequentially read location of specified index entries, the specified index entries correspond to the terms of a query. A display module presents qualified pages located by the search engine to users of the Web.

Such a system allows data to be accessed also from multiple distributed sources according to a surfer's query. However, in neither of the above-referenced patents is there any suggestion to utilize navigation and search strategies emanating from distinct and disassociated sources to correlate their interests and allow cross-connection between two or more users having overlapping navigation and/or search interests. Such “navigation and/or search strategies” as referred to throughout the description and appended claims include at least a URL and optionally keywords derived from a keyword search within a selected web site.

U.S. Pat. No. 5,794,210 (Goldhaber et al) discloses a system for the immediate payment to computer and other users for paying attention to an advertisement distributed over a computer network, such as the Internet. At col. 20, lines 56-57 the automatic formation of on-line communities of interest is discussed as an extension of trading houses. In this connection, it is observed that existing on-line service provide “news groups” or “chat groups” dedicated to specific interests, but these must be formed “manually” and then “advertised” by e-mail or word of mouth. As opposed to this, U.S. Pat. No. 5,794,210 proposes the use of an interest-matching brokerage service allowing a consumer to make a request such as “please put me in touch with other people like myself”. Such requests can trigger the automatic formation of an appropriate news group or chat room, and the automatic notification of interested members.

No mechanism is actually provided in U.S. Pat. No. 5,794,210 for achieving this objective and it is therefore difficult to see how an appropriate news group or chat room may be constructed automatically from a user-initiated search request, as described. There is no suggestion to log users' navigation and/or search strategies in order to compile and update a global database allowing all users to the network to locate other like-minded users based on their navigation and/or search histories.

Moreover, U.S. Pat. No. 5,794,210 relates to existing communities of users having shared interests. Common interests amongst members of such communities may well share different combinations of interests which individually are thus not common to other members of the same community. For example, several members of a community may share a pre-defined interest group, such as science fiction, at one level or another. However, the group is not optimized to the individual, who is a member in the group, since probably only few of the members hold science fiction as a first priority of interest. It would therefore be preferable for the definition of the interest to be generated automatically for the individual, based on his personal level of interest, for each subject.

It is thus apparent that the prior art provides no mechanism for locating other users having similar search interests and navigation and/or search strategies. Whilst search engines abound for searching for specific types of data, it has not been suggested to locate people all searching for the same information.

### SUMMARY OF THE INVENTION

It is an object of the invention to provide a method for allowing disassociated web surfers having overlapping search needs and/or navigation and/or search strategies to become aware of each other's existence.

This object is realized in accordance with a broad aspect of the invention by a computer implemented method for allowing a first web surfer to locate at least one second web surfer having similar navigation and/or search strategies, said method comprising the following steps all carried out by a web server in communication with said first and at least one second web surfers:

(a) receiving key words and/or URLs derived by parsing respective navigation strings from all web surfers in communication with the web server in order to extract respective URLs of web sites visited by the web surfers and/or keywords indicative of a navigation string,

(b) compiling a database of said keywords and URLs including a URL of each respective web surfer, and

(c) cross-referencing the database for similar keywords and/or URLs to those of the first web surfer so as to locate said at least one second web surfer.

Such a method is carried out by a web server having the database stored either thereon or in association therewith. Once the database has been established, it requires maintenance by the web server. Such maintenance includes checking whether the currently parsed keywords and URLs already exist in the database, and updating the database either with the new data or incrementing a counter showing a cumulative usage of the keywords or URLs.

In practice the database may itself be distributed amongst various web servers, each one of which carries out the method according to the invention. The parsing of the navigation and/or search strategies in order to extract the URLs visited by the web surfers and the key words may be carried out also by the web server storing or managing the database. Likewise, the parsing may be done at the surfer's machine and the parsed data then downloaded to the web server. More usually, however, multiple web servers are distributed geographically and the web server closest to a particular web surfer receives and parses the navigation patter and then passes the URLs and key words to the database server or to a web server associated therewith.

In order to emphasize the uniqueness of the grouping mechanism in the present invention, it is important to understand that each individual is a seed and/or source for a new group. Each one defines a new group. Theoretically, there can exist as many groups as the number of the individuals members. Therefore, the quality of the match achieved by the invention is optimized, eliminating an unreal match between the members. Only members who prove similar Navigation and/or search strategies, as defined, will share the same interest group. Furthermore, since the individual priorities change, the group is dynamic: the group of any individual today may be different than the group of the very similar individual a day after, of course, based on his Navigation and/or search strategy.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a pictorial representation of a distributed network for identifying disassociated web surfers having overlapping search needs and/or navigation and/or search strategies in accordance with the invention;

FIG. 2 is a detailed pictorial representation of the network of FIG. 1 including information flow;

FIG. 3 is a table showing exemplary navigation data compiled in a database for enabling subsequent identification of disassociated web surfers;

FIGS. 4a and 4b are flow diagrams showing the principal operating steps carried out by a Web Server for compiling databases of URLs and search strings;

FIG. 5 is a pictorial representation of a network including a web server adapted to use multiple search engines simultaneously using a single search inquiry;

FIG. 6 shows pictorially a Graphical User Interface for use by a Web Browser for providing optional integration with other search engines;

FIG. 7 is a flow diagram showing the principal operating steps carried out by the Web Server in the network of FIG. 5; and

FIGS. 8a to 8d are flow diagrams showing the principal operating instructions associated with the matching procedure according to the invention.

### DETAILED DESCRIPTION OF THE INVENTION

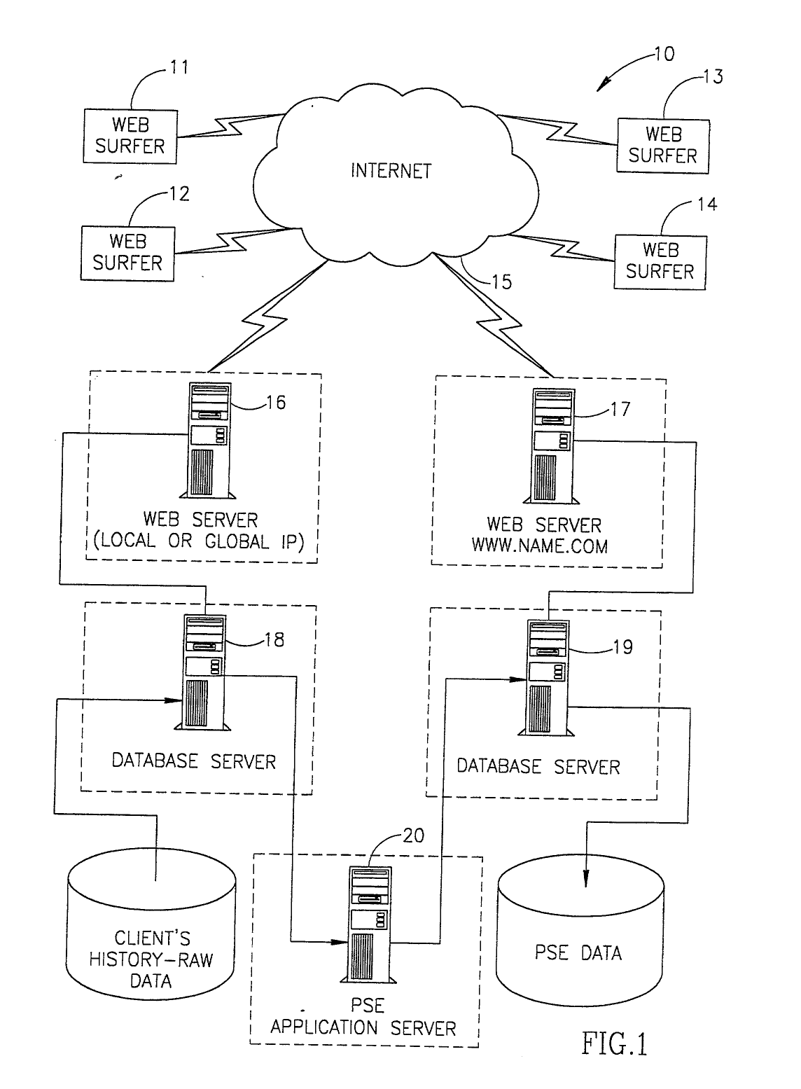

FIG. 1 shows pictorially a network 10 comprising a plurality of disassociated and mutually remote web surfers 11, 12, 13 and 14 (constituting “clients”) connected via the Internet 15 to web servers 16 and 17. The web servers 16 and 17 are connected to respective Database servers 18 and 19, which are connected to an application server 20. The Database server 18 contains a memory in which there is stored raw data constituting the client history of the web surfers 11, 12, 13 and 14. The Database server 19 contains a memory in which there are stored results of a query undertaken by the Database server 18 for determining overlapping fields of interest of the web surfers.

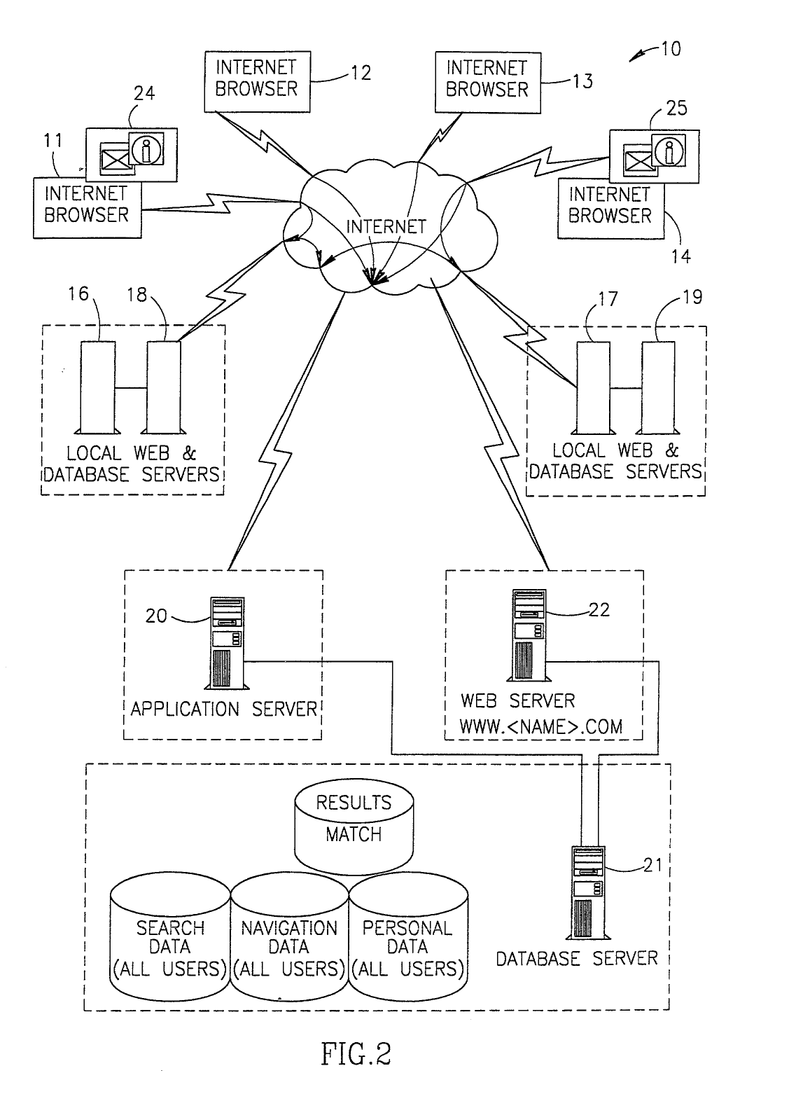

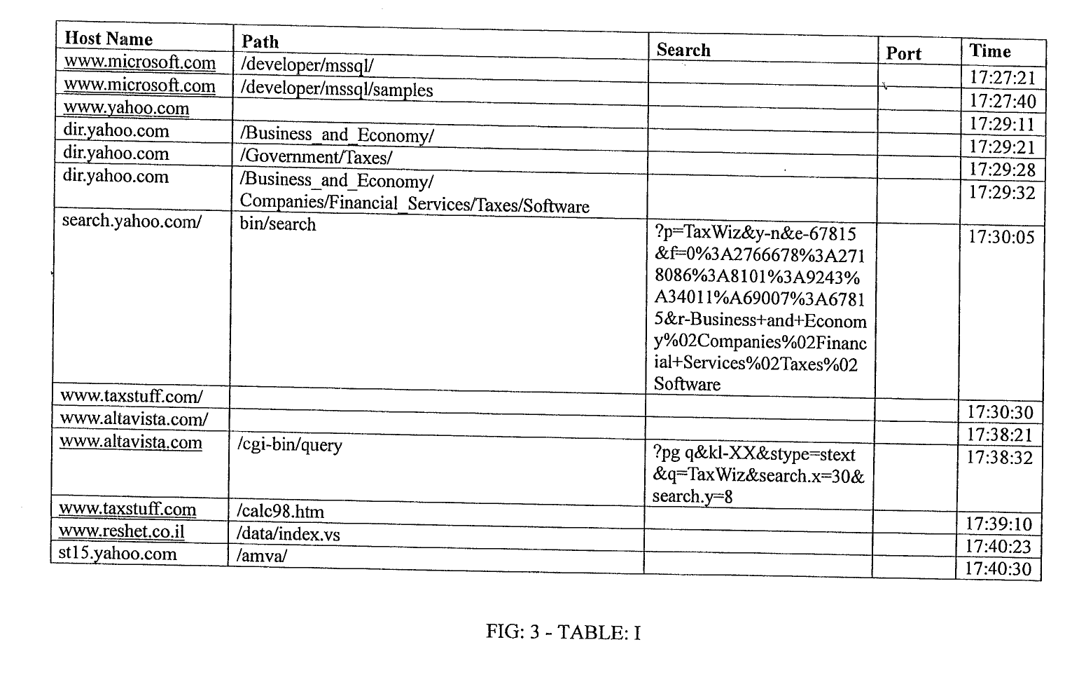

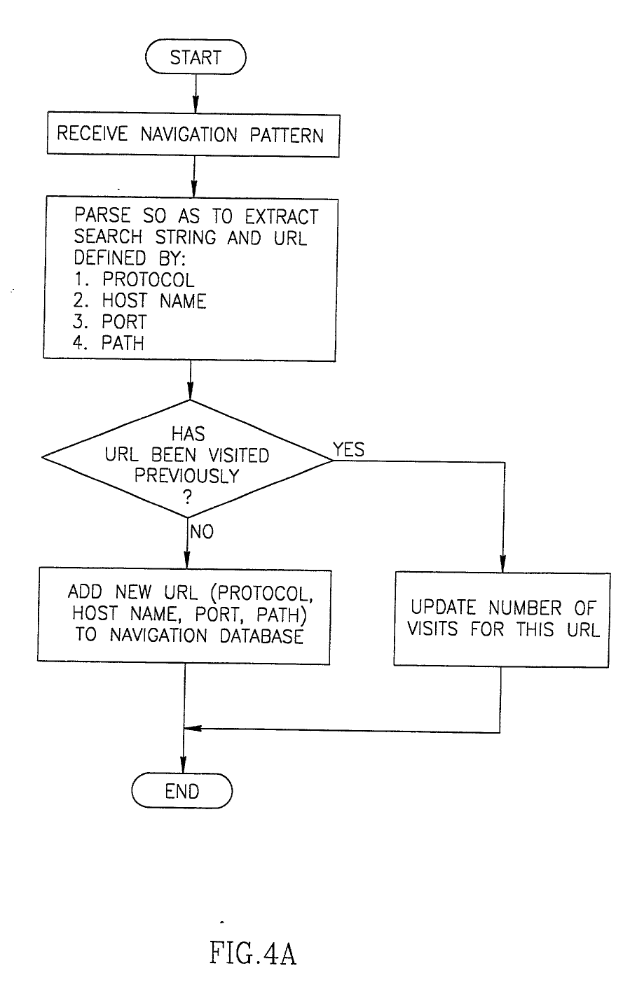

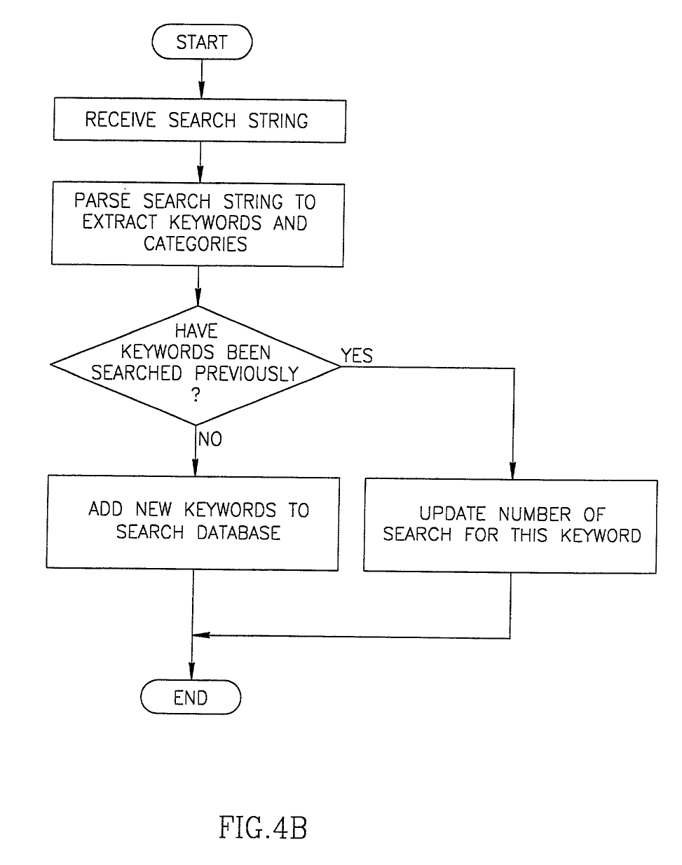

FIG. 2 shows the flow of information through the network 10. The web surfers 11 to 14 access the Internet 15 via web browsers. The web surfers 11 and 14 are downloaded and installed via the Internet proprietary software enabling the system to receive the navigation strings according to the invention, as will be described in detail with reference to FIGS. 3 and 4 of the drawings. It will be noted that the functions of the Database servers 18 and 19 shown in FIG. 1 are distributed in FIG. 2 between the Database servers 18 and 19 (constituting local Database servers) and a primary Database server 21. Likewise, the web server 16 constitutes a local web server, which is reinforced by the primary server 22 in communication with the primary Database server 21. The Database server 21 stores databases of the personal details including URLs of all web surfers accessing the web servers 16 and 17, their navigation and/or search strategies. A further database stores matching results for a specific client based on comparing her keywords and URLs with those of all known clients whose navigation and search data have been previously recorded.

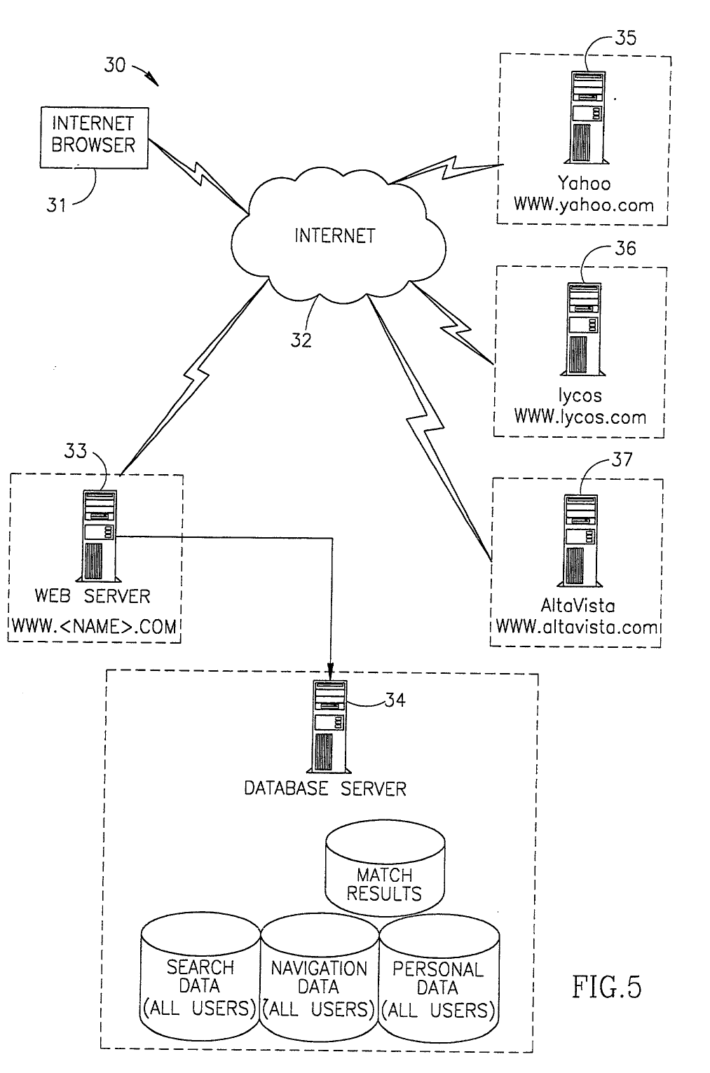

As shown in FIG. 2, typical users will use a web browser 11 or 14 to download, install and use a proprietary software module 24-25. Such users will automatically feed the system with their Navigation strings, allowing the system to compile while specifying the Navigation and/or search strategies. However, users 12 and 13 who choose not to download and/or install the proprietary software module, but instead use only the web browser, may use limited features of the invention as described below with reference to FIG. 5 of the drawings.

The sequence of operation will now be explained with reference to FIG. 3, whilst FIGS. 4b and 4c show in more detail the principal steps carried out by the web server for compiling the navigation and search databases shown in FIG. 2. Whenever any one of the web surfers accesses a web site, navigation and/or search strategies entered by the web surfer and stored locally in the client machine by the web browser and sent to the local web server at regular periods of time. When the web servers 16 or 17 acknowledges receiving the transferred data, it is deleted from the client machine. This eliminates the need for large storage capacity on the client's machine. The client does not need to establish its own dial-up or other Internet communication as it uses the open Internet connection established by the browser. Sending the data from the client to the web server in small batches is advantageous in that, in the event of a lost connection between the client and the web server, the only data which remains on the client's machine relates to those URLs visited since the previous batch update prior to the disconnection. The time between updates should therefore be optimized to render the optimal combined performance of both the user's machine and the web server.

It is to be noted that whilst the web server always receives the key words and/or URLs derived by parsing respective navigation strings, it does not necessarily itself have to perform the parsing which can be done by a distributed server in the network.

In the table in FIG. 3, the first column shows the Host Name, this being the URL of the specified web site. The second column indicates the path within the specified web site accessed by the client and the third column shows the search string, where applicable. It will be noticed that the search string is introduced with a question mark “?” followed by the search string itself. The fourth column (when used) shows the port and allows the invention to be extended also for Intranet use, whereby different users interconnected by a local area network may utilize the search engine according to the invention. The fifth column shows the time when the corresponding navigation pattern was executed, and allows a predetermined number of those matching users who most recently initiated similar searches to be identified.

The above data is created by the web browser in the client machine and is stored there until the server acknowledges receiving it, whereupon it is deleted from the client machine. This obviates the need for large storage capacity on the client's workstation. The client does not need to establish its own dial-up or other Internet communication as it uses the open Internet connection established by the browser. Sending the data from the client to the web server in small batches is advantageous in that, in the event of a lost connection between the client and the web server, the only data which remains on the client's machine relates to those URLs visited since the previous batch update prior to the disconnection. The time between updates should therefore be optimized to render the optimal combined performance of both the user's machine and the web server.

The web server 16 or 17 receiving the data from the web surfers can be the global server having a URL www.name.com as shown in FIG. 1 or may be one of many local servers as shown in FIG. 2. The local server option will be activated when bandwidth restrictions so dictate. It also improves performance as communication between a web surfer and the local server will not tolerate long distance congestion. The web server performs no manipulation of the received data but passes it directly to the database server 19 and then sends an acknowledge signal to the web surfer machine informing it that the data has been received and stored. The web surfer machine may then delete the data from its own memory.

The result of many web surfers navigating or “surfing” the Internet is therefore that the database server 19 (shown in FIG. 1) collects and stores a large number of navigation patterns of the kind shown in the above table. The database server 19 processes this data in order to extract the URLs of all web sites visited by the web surfers as well as keywords and navigation patterns. For example, with further reference to the above table, keywords of the kind “tax”, “financial_services” and “software” are extracted and indexed in the database.

The Web Browser used by the web surfers 11 to 14 initially has a “Match” command button on his or her graphical user interface generated by the web site. At this point, the web surfer is connected via the Internet 15 to the web server and has already been authenticated as an authorized user of the system.

The database is split into Active and Archive data, so as to increase speed and reliability. By default, the database provides immediate access to the top six (or other predefined) “Active” URLs matching the web surfer's navigation pattern. However, the web surfer can request custom matching wherein filtering criteria are applied to the matching URLs. For example, the web surfer may wish to identify all other web surfers having matching “Navigation History”, “Search History” but not matching “Personal Profile” corresponding to Male, aged 25-35 with fluent English. In this case, the Archive data is also accessed to find matching URLs.

The web browser manipulates the data from the web surfers' navigation and/or search strategies (constituting raw history data) which are then fed to the Database server 18. Upon receiving a new navigation string from the web surfer's browser, the navigation string is parsed in order to extract the URL and search words, if any. The current database is scanned in order to determines whether these URL and search words already exist and, if so, no further action is taken apart incrementing an internal counter. The internal counter records thereby the number of times the browser has connected to a specific site and this too affords a measure of interest associated with the site. Moreover, by obviating the need to augment the database in respect of sites visited by the same surfer many times, the size of the database may be maintained within manageable proportions. This both saves storage space and increases efficiency, thus allowing scalability of the invention. Otherwise, the application server 20 feeds the URL and/or search words to the database server 19 where they are added to the database.

The process of updating data from the client machines used by the web surfers may be performed in parallel with any searches undertaken by the web surfers, and the one does not interfere or degrade the performance of the other. Further, since navigation and/or search strategies that are processed constitute raw history data derived after a search has been initiated as opposed to real-time data derived during the act of performing a search. Therefore, the manipulation of the navigation and/or search strategies may be performed when it is most convenient to the system without noticeably degrading overall system performance. Performance may be further enhanced by providing more than one server for processing the raw history data each serving one or more local servers, as shown in FIG. 2.

### EXAMPLE

To understand the invention, consider the following example of a web surfer looking for information about “cooking”. Client software is installed on the web surfer's machine, typically as an adjunct to the web browser, to locate other web surfers havig similar search interests. The web surfer navigates to the CNN site having a URL http://www.cnn.com, this being the navigation pattern shown as the browser address upon completing connection to the CNN web site.

The client software records the following information into its temporary database on the web surfer's workstation:

| Protocol: | http |
|---|---|
| HostName: | www.cnn.com |
| Port: | “” |
| Path: | “” |
| Search: | “” |
| Time: | 17:27:21 |

The web surfer remains in the CNN web site and clicks the sub-category “food” followed by the sub category “how to” which is itself followed by the sub category “how to boil an egg”. The browser address is now shown as http://www.cnn.com/FOOD/howto/101/boil.egg/index.html.

The client software tracks the new address shown by the browser each time the web surfer clicks on a new path. Thus, the final record added to the temporary database on the web surfer's workstation is as follows:

| Protocol: | http |
|---|---|
| HostName: | www.cnn.com |
| Port: | “” |
| Path: | “FOOD/howto/101/boil.egg” |
| Search: | “” |
| Time: | 17:28:11 |

The web surfer now decides further to explore the art of boiling eggs and, to this end, uses the built-in Search text box provided at the CNN page “how to boil an egg”. The user types the key words “Boil Eggs” and clicks the search button. The web browser displays the following URL address:

http://search.cnn.com/query.html?qt=%22boil+eggs%22&qc-&001=cnni&qm=0&st=1&nh=10&ik=1&rf=1. The client software now adds the following information to its temporary database:

| Protocol: | http |
|---|---|
| HostName: | www.cnn.com |
| Port: | “” |
| Path: | “” |
| Search: | “qt=%22boil+eggs%22&qc- |
| | &001=cnni&qm=0&st=1&nh |
| | =10&ik=1&rf=1” |
| Time: | 17:39:10 |

It will be noted that upon performing a search, there is stored an entry for the search field, this being the entire text string following the “?” in the address shown by the web browser. Thus, as the web surfer surfs the web and clicks on different addresses, more search strings are added to the temporary database stored on the client machine. At regular time intervals, the client software feeds these search strings to the local server and then deletes them from the temporary database.

In order now to locate other web users having similar search interests, the web surfer clicks on a “find a match” icon at his or her web browser. The web addresses visited by the web surfer's browser and recorded in the database are now used as a reference for locating other relevant users. This is done as follows:

parse the current address pointed to by the web browser in order to extract URL and key word data;

send the URL and key word data from the client machine via the local web server 16 to the database server 19;

extract a desired number of matching entries from the database and feed back to the same local web server that initiated the query;

feed back the matching entries from the local web server to the client and display.

FIGS. 4a and 4b show the manner in which the database maintenance may be carried out in practice. Thus, a received navigation string is parsed so as extract the search string and URL, defined by protocol, host name, port and path. If the URL has not been visited previously, then the new URL is added to the navigation database. Otherwise, the number of visits for this URL is incremented. Likewise, a received search string is parsed so as extract the keywords and categories. If the keywords have not been visited previously, then the new keywords are added to the search database. Otherwise, the number of searches for this keyword is incremented.

In fact, part of this procedure may be performed in the background even before the web surfer clicks on the “find a match” icon, in order to pre-fetch a specified number of matching entries to the client machine. These may be displayed in a window, if desired, or be stored without displaying so as to be immediately available when the web surfer clicks on the “find a match” icon.

It will be appreciated that the parsing of web site addresses may in fact be done by any node in the communication network. Thus, the client machine may itself parse the web addresses and then feed the URLs and key words to the local web server for forwarding to the database server. Alternatively, the client machine can feed the raw web site address to the local web server, where it can be parsed in order to extract the URLs and key words for feeding to the database server. Finally, of course, the raw web site addresses can be fed by the local web server to the database server for parsing and storage.

The invention has been described thus far with regard to a mechanism for locating other web users having similar search interests. To this end, as explained, each web surfer's navigation and/or search strategies are parsed so as to allow critical components to be extracted and stored in a database. To this end, the proprietary software stored in the local web server is adapted to parse incoming navigation and/or search strategies. By the same token, it may be adapted to reconstruct navigation and/or search strategies from keywords and URLs appropriate for a designated search engine. This allows multiple search engines to be accessed simultaneously by the web server 16 or 17, based on the entry of a single navigation pattern or keyword search string by the web surfer.

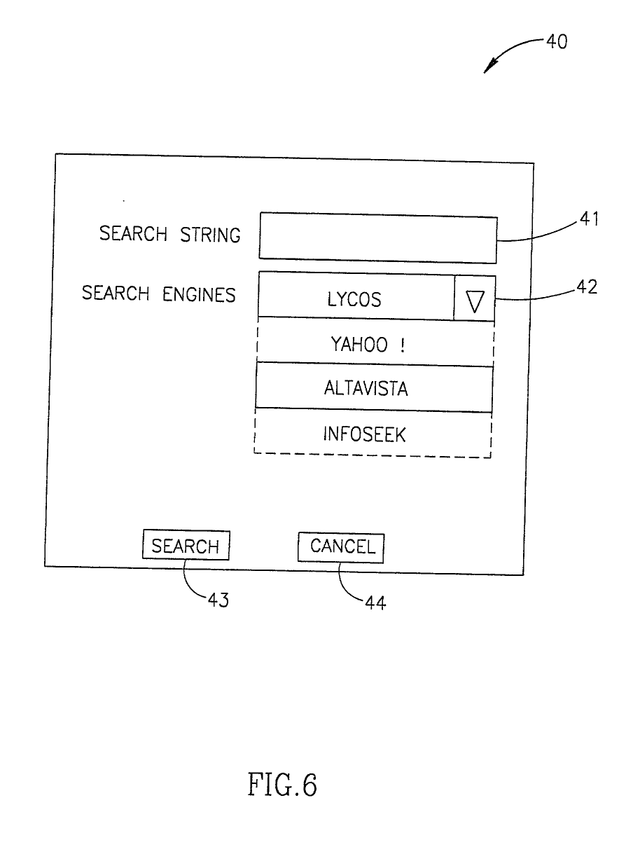

FIG. 5 shows pictorially a detail of a network 30 wherein a client machine 31 having a web browser is connected via the Internet 32 to a web server 33. The web 30 server 33 is connected to a Database server 34, as described above with reference to FIGS. 1 and 2 of the drawings. The web browser 31 can also access through the Internet 32 the web sites 35, 36, 37 of standard search engines, such as Yahoo!, Lycos and AltaVista. FIG. 6 shows pictorially a graphical user interface (GUI) 40 which is downloaded within an applet from the web server 43 to the client machine as generated by the web site and which comprises a text box 41 for entering a search string and a combo-box 42 for specifying one or more search engines. These may be common search engines such as Yahoo!, Lycos, AltaVista, InfoSeek and the like which are pre-displayed for selection in known manner. Alternatively, they may be less common search engines, which may be freely entered by the user. Upon clicking the search command key 43, each of the selected search engines performs a search for the specified key words and displays the results in a respective window opened by the user's browser.

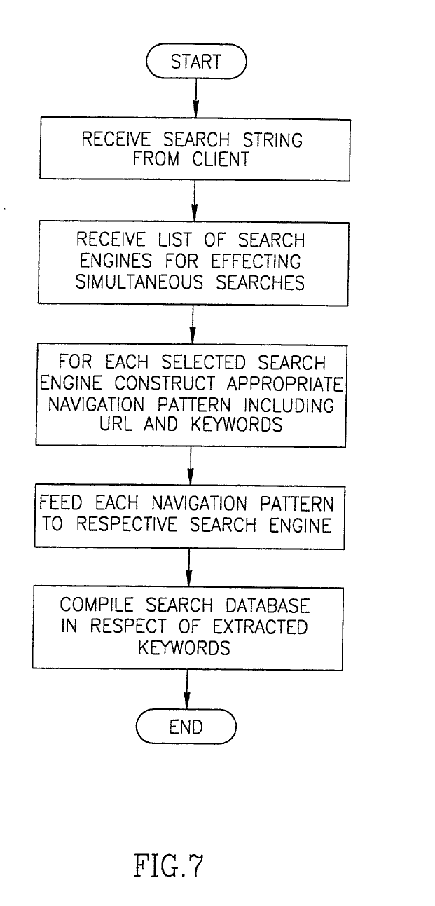

FIG. 7 is a flow diagram showing the principal steps carried out by the web server 33 for effecting multiple searches simultaneously. Thus, the web server receives a search string from the client as well as a list of search engines for effecting simultaneous searches. For each selected search engine, the web server constructs an appropriate navigation pattern, which includes URL and keywords. Each navigation string is fed to the respective search engine, which opens a new window for displaying search results to the client through the Internet, this being transparent to the application executed by the web server. The selected keywords are also passed to the primary Database server 21 (shown in FIG. 2) and are added to the search database containing keywords in respect of each client accessing the web server 33. If the keyword already exists in the client's search database, a cumulative usage total for the specified keyword is updated as shown in FIG. 4c. This information is then used by the “find a match” module described above with reference to FIGS. 1 to 4a, 4b and 4c of the drawings.

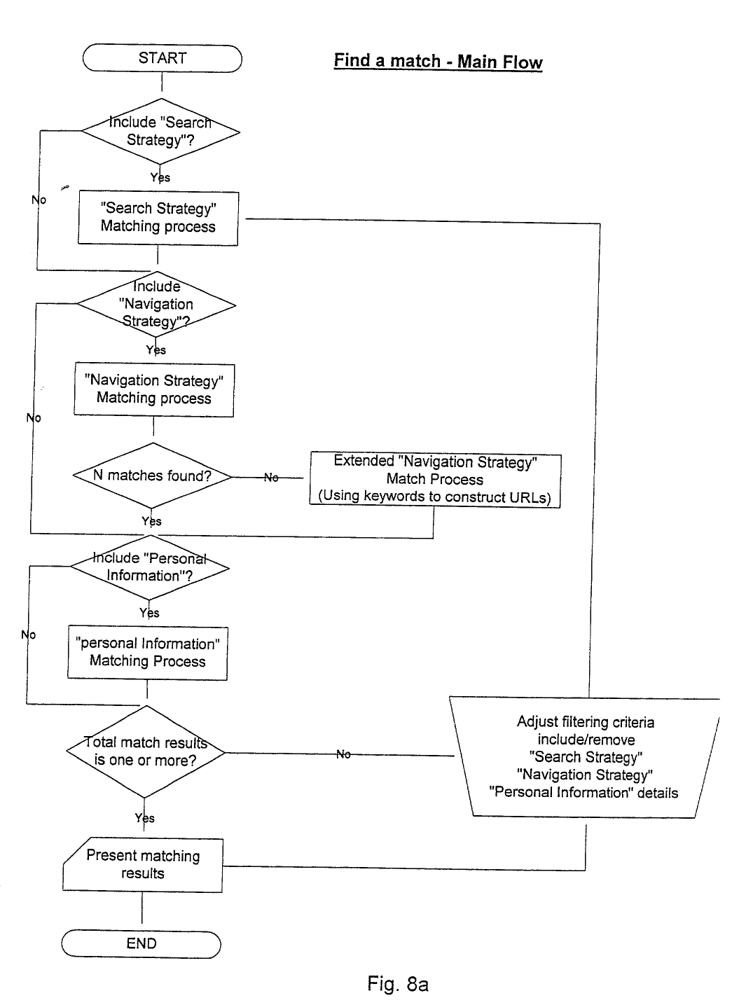

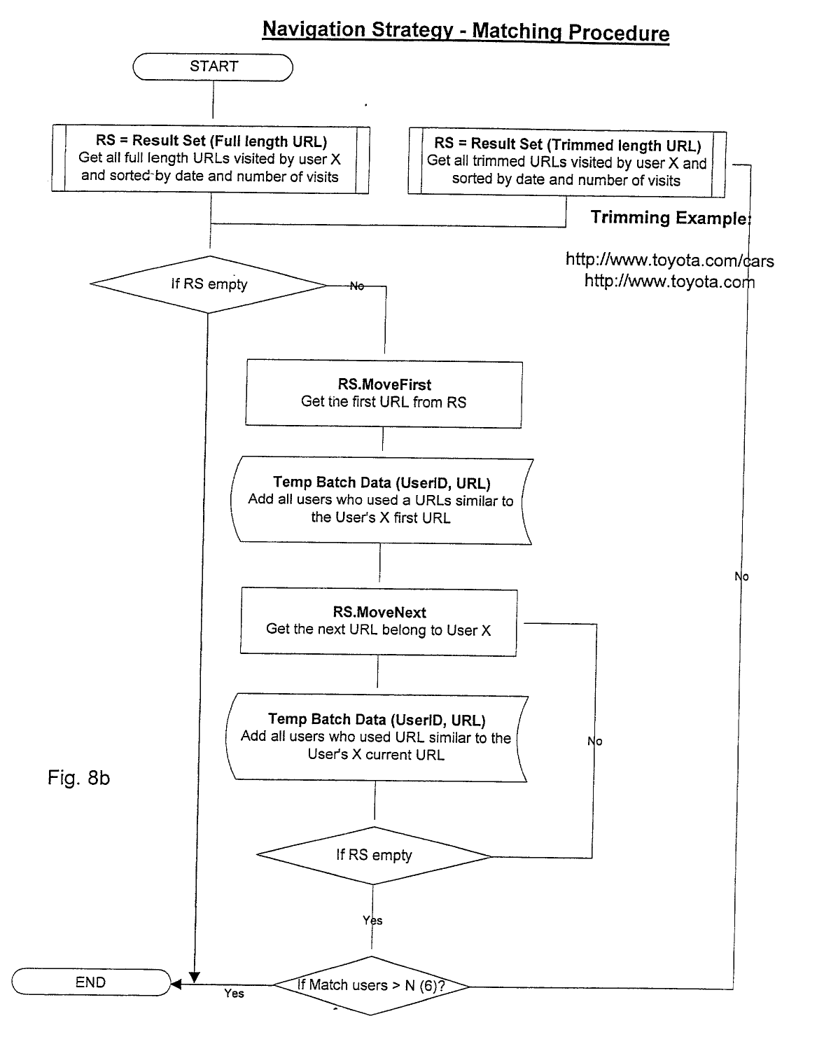

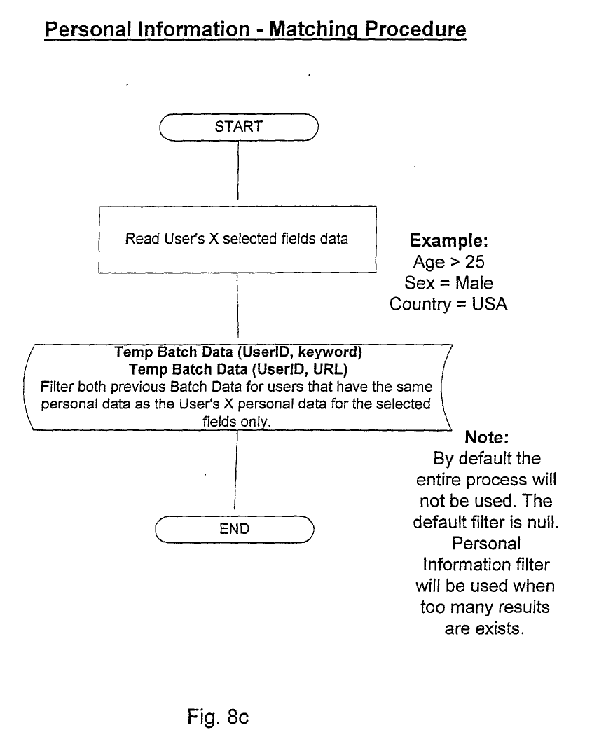

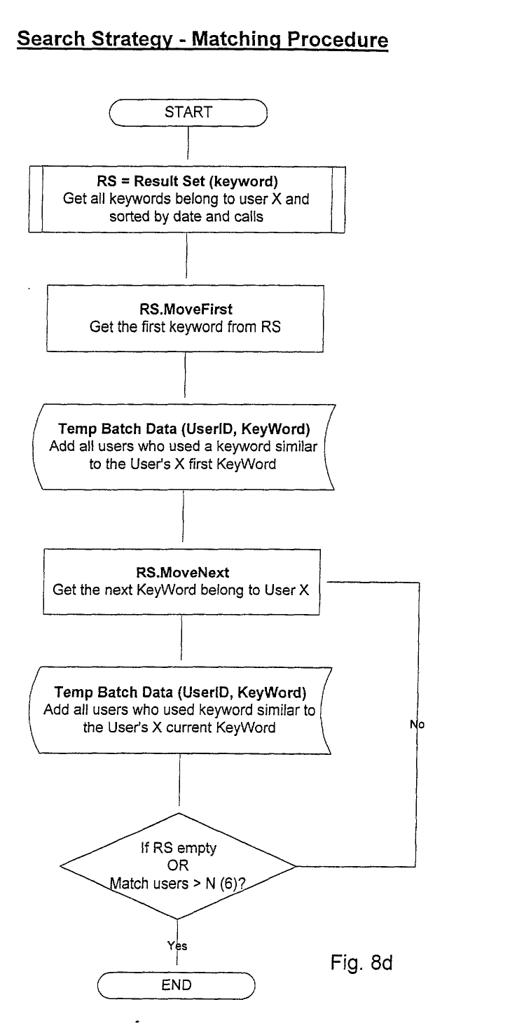

FIGS. 8a to 8d show in more detail the principal operating steps carried out by the matching procedure according to the invention.

The invention is able to define the navigation and/or search strategy by synonyms related to the keywords. i.e. comparing words not only between a keyword and the same keyword but also between a keyword and its synonym. This is important especially when different users use the same language for searching but are not equally skilled in that language. Therefore, a keyword will be defined as either a keyword or its synonym.

Also, the invention is able to map between languages referring to the same meaning of a keyword or its synonym.

Additionally, the invention allows a web surfer to view a complete search history of a matching web surfer subsequent to typing the keyword common to both surfers, so as to show matching web surfers the URLs of sites subsequently visited. This is explained by way of the following detailed example:

User X File:

Profile: student, USA, 20 years old, hobby: surf . . .

Key words searched: Mobile+phone, MP3+Bowie . . .

Sites visited: www.Motorola.com, www.Nokia.com, www.mercata.com, www.MP3.com, www.bowie.com

User #1:

Profile: doctor, GB, 35 years old, hobby: golf . . .

Key words searched: Mobile+phone, surgery+online . . .

Sites visited: www.Motorola.com, www.surgery.com, www..com, www.netscape.com

User #2:

Profile: finance, GB, 40 years old, hobby: tennis . . .

Key words searched: MP3+Bowie, aol+financial+results, stock+amazone . . .

Sites visited: www.bowiefans.com, www.davidbowie.com, www.popMusic.com, www.IPOcentral.com, wwwaol.com, www.reuters.com, www.zdnet.com,

User #3:

Profile: student, USA, 19 years old, hobby: chess . . .

Key words searched: help+mathematic, Kasparov . . .

Sites visited: www.Bowie.com, www.bestofBowie.com, www.IBM.com, www.kasparov.com, www.netscape.com

User X performs a match through his file composed of the three lists: profile given by him, key words and sites he has visited. The results of the match are the user's files that have the most similarities to those of X. In this example, the profile list is not selected as a criterion for the match.

| Users | Key words searched | Sites visited |
|---|---|---|
| User 1 | >>Mobile + phone | >>www.Motorola.com |
| | | www.netscape.com |
| | surgery + online | www.surgery.com |
| User 2 | stock + amazone | www.reuters.com |
| | >>MP3 + Bowie | www.bowiefans.com |
| | | www.davidbowie.com |
| | | www.popmusic.com |
| | aol + financial + results | www.aol.com |
| | | www.zdnet.com |
| User 3 | help + mathematic | www.netscape.com |
| | Kasparov | www.kasparov.com |
| | | www.JBM.com |
| | | www.Bowie.com |
| | | www.bestofBowie.com |

The invention allows the matching search results to be displayed as above, i.e. showing the key words searched by each user in connection with the sites subsequently visited. Such presentation is useful for user X to identify easily which sites to visit in relation with key words he searched. In this example, he will discover the following sites:

www.bowiefans.com, www.davidbowie.com, and www.popmusic.com in relation with the Key words MP3+Bowie searched in common (user 2)

The site www.bestofBowie.com, since it comes after the site www.Bowie.com visited in common (user 3)

The user may use a privacy option when he does not want other users to see a specific search and navigation that he had performed, either in whole or in part.

When the user uses the multiple search engines, for a specific keyword, the result of the search does not appear at the database server but rather at the search engine site (such as Yahoo!). The database server is also in fact a “hyperlink” in order to refer to the different search engines. However, the word that the user has searched for, is also recorded at the database server.

It will be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

In the method claims that follow, alphabetic characters used to designate claim steps are provided for convenience only and do not imply any particular order of performing the steps.

1. A computer implemented method for allowing a first web surfer to locate at least one second web surfer having similar navigation and/or search strategies, said method comprising the following steps all carried out by a web server in communication with said first and at least one second web surfers:
(a) receiving key words and/or URLs derived by parsing respective navigation strings from all web surfers in communication with the web server in order to extract respective URLs of web sites visited by the web surfers and/or keywords indicative of a navigation string,
(b) compiling a database of said keywords and URLs including a URL of each respective web surfer, and
(c) cross-referencing the database for similar keywords and/or URLs to those of the first web surfer so as to locate said at least one second web surfer.

2. The method according to claim 1, further including:
(d) informing the first web surfer of the URL of the at least one second web surfer.

3. The method according to claim 1, further including:
(e) automatically communicating between the first and the at least one second web surfers.

4. The method according to claim 1, further including:
(f) automatically sending respective URLs of a predetermined number of matching second web surfers for pre-fetching by the first web surfer.

5. The method according to claim 1, further including:
(g) receiving the respective navigation and/or search strategies from each of the web surfers, and
(h) parsing the respective navigation and/or search strategies to derive said key words and/or URL.

6. The method according to claim 1, further including:
(i) downloading to a client machine a mobile software module for collating navigation and/or search strategies entered to a web browser of the client machine and downloading to a local web server.

7. The method according to claim 1, wherein step (b) includes:
i) checking whether the URL has been visited previously,
ii) if not, adding the URL to a navigation database,
iii) if so, updating a counter indicating a cumulative number of visits for said URL,
iv) checking for each keyword whether the keyword has been visited previously,
v) if not, adding the keyword to a search database,
vi) if so, updating a counter indicating a cumulative number of uses of the keyword.

8. The method according to claim 1, further including:
(j) receiving from the web surfer a search string as well as a list of search engines for effecting simultaneous searches,
(k) for each selected search engine, constructing an appropriate navigation pattern including URL and keywords, and
(l) feeding each navigation string to a respective search engine.

9. A web server for allowing a first web surfer to locate at least one second web surfer having similar navigation and/or search strategies, said web server comprising:
a receiving port for receiving key words and/or URLs derived by parsing respective navigation and/or search strategies from all web surfers in communication with the web server in order to extract respective URLs of web sites visited by the web surfers and/or key words indicative of a navigation string,
a memory coupled to the receiving port for storing a database of said key words and URLs including a URL of each respective web surfer,
a processor coupled to the memory for compiling the database as new keywords and URLs are received, and
a search module for cross-referencing the database for similar key words and/or URLs to those of the first web surfer so as to locate said at least one second web surfer.

10. The web server according to claim 9, further including:
an indication unit for informing the first web surfer of the URL of the at least one second web surfer.

11. The web server according to claim 9, further including:
a connection unit for automatically communicating between the first and the at least one second web surfers.

12. The web server according to claim 9, wherein the indication unit includes:
a buffer for storing respective URLs of a predetermined number of matching second web surfers, and
a pre-fetching module for automatically sending the respective URLs of said predetermined number of matching second web surfers to the first web surfer for pre-fetching by the first web surfer.

13. The web server according to claim 9, further including:
a navigation buffer for receiving the respective navigation and/or search strategies from each of the web surfers, and
a parsing module coupled to the navigation buffer for parsing the respective navigation and/or search strategies to derive said key words and/or URL.

14. The web server according to claim 9, further including:
a memory for storing a mobile software module for collating navigation and/or search strategies entered to a web browser of the client machine and downloading to a local web server, and
a communication module coupled to said memory for downloading the mobile software module to a client machine.

15. The web server according to claim 9, wherein the processor is adapted to:
i) check whether the URL has been visited previously,
ii) if not, add the URL to a navigation database,
iii) if so, update a counter indicating a cumulative number of visits for said URL,
iv) check for each keyword whether the keyword has been visited previously,
v) if not, add the keyword to a search database,
vi) if so, update a counter indicating a cumulative number of uses of the keyword.

16. The web server according to claim 9, further including:
a search buffer for receiving from the web surfer a search string as well as a list of search engines for effecting simultaneous searches, and
a navigation pattern module coupled to the search buffer for constructing an appropriate navigation pattern including URL and keywords for each selected search engine, and feeding to a respective search engine.

17. A computer implemented program storage device readable by machine, tangibly embodying a program of instructions executable by the machine to perform method steps for allowing a first web surfer to locate at least one second web surfer having similar navigation and/or search strategies, said method steps comprising:
(a) receiving key words and/or URLs derived by parsing respective navigation and/or search strategies from all web surfers in communication with the web server in order to extract respective URLs of web sites visited by the web surfers and/or key words indicative of a navigation string,
(b) compiling a database of said key words and URLs including a URL of each respective web surfer, and
(c) cross-referencing the database for similar key words and/or URLs to those of the first web surfer so as to locate said at least one second web surfer.

18. A computer implemented computer program product comprising a computer useable medium having computer readable program code embodied therein for allowing a first web surfer to locate at least one second web surfer having similar navigation and/or search strategies, said computer program product comprising:
computer readable program code for causing the computer to receive key words and/or URLs derived by parsing respective navigation and/or search strategies from all web surfers in communication with the web server in order to extract respective URLs of web sites visited by the web surfers and/or key words indicative of a navigation string,
computer readable program code for causing the computer to maintain a database of said key words and URLs including a URL of each respective web surfer, and
computer readable program code for causing the computer to cross-reference the database for similar key words and/or URLs to those of the first web surfer so as to locate said at least one second web surfer.

19. A computer implemented method for allowing a first web surfer to locate at least one second web surfer having similar navigation and/or search strategies, said method comprising the following steps all carried out by a web server in communication with said first and at least one second web surfers:
(a) receiving key words and/or URLs derived by parsing respective navigation and/or search strategies from all web surfers in communication with the web server in order to extract respective URLs of web sites visited by the web surfers and/or key words indicative of a navigation string,
(b) uploading said key words and URLs including a URL of each respective web surfer to a remote database, and
(c) downloading from the database similar key words and/or URLs to those of the first web surfer so as to locate said at least one second web surfer.

20. The method according to claim 19, further including:
(d) informing the first web surfer of the URL of the at least one second web surfer.

21. The method according to claim 19, further including:
(e) automatically communicating between the first and the at least one second web surfers.

22. The method according to claim 19, further including:
(f) automatically sending respective URLs of a predetermined number of matching second web surfers for pre-fetching by the first web surfer.

23. The method according to claim 19, further including:
(g) receiving the respective navigation and/or search strategies from each of the web surfers, and
(h) parsing the respective navigation and/or search strategies to derive said key words and/or URL.

24. The method according to claim 19, further including:
(i) downloading to a client machine a mobile software module for collating navigation and/or search strategies entered to a web browser of the client machine and downloading to a local web server.

25. The method according to claim 19, further including:
(j) receiving from the web surfer a search string as well as a list of search engines for effecting simultaneous searches,
(k) for each selected search engine, constructing an appropriate navigation pattern including URL and keywords, and
(l) feeding each navigation string to a respective search engine.

26. The method according to claim 25, further including:
(m) adding the keywords to a search database on said web server containing keywords in respect of said client.

27. The method according to claim 25, further including:
(m) passing the keywords to a remote database server search database containing keywords in respect of said client.

28. A web server for allowing a first web surfer to locate at least one second web surfer having similar navigation and/or search strategies, said web server comprising:
a receiving port for receiving key words and/or URLs derived by parsing respective navigation and/or search strategies from all web surfers in communication with the web server in order to extract respective URLs of web sites visited by the web surfers and/or key words indicative of a navigation string,
a database port coupled to the receiving port for uploading said key words and URLs including a URL of each respective web surfer to a remote database as new keywords and URLs are received, and
a search module for cross-referencing the database for similar key words and/or URLs to those of the first web surfer so as to locate said at least one second web surfer.

29. The web server according to claim 28, further including:
an indication unit for informing the first web surfer of the URL of the at least one second web surfer.

30. The web server according to claim 28, further including:
a connection unit for automatically communicating between the first and the at least one second web surfers.

31. The web server according to claim 28, wherein the indication unit includes:
a buffer for storing respective URLs of a predetermined number of matching second web surfers, and
a pre-fetching module for automatically sending the respective URLs of said predetermined number of matching second web surfers to the first web surfer for pre-fetching by the first web surfer.

32. The web server according to claim 28, further including:
a navigation buffer for receiving the respective navigation and/or search strategies from each of the web surfers, and
a parsing module coupled to the navigation buffer for parsing the respective navigation and/or search strategies to derive said key words and/or URL.

33. The web server according to claim 28, further including:
a memory for storing a mobile software module for collating navigation and/or search strategies entered to a web browser of the client machine and downloading to a local web server, and
a communication module coupled to said memory for downloading the mobile software module to a client machine.

34. The web server according to claim 28, further including:
a search buffer for receiving from the web surfer a search string as well as a list of search engines for effecting simultaneous searches, and
a navigation pattern module coupled to the search buffer for constructing an appropriate navigation pattern including URL and keywords for each selected search engine, and feeding to a respective search engine.

35. The web server according to claim 34, further including:
a database processor for adding the keywords to a search database on said web server containing keywords in respect of said client.

36. The web server according to claim 34, further including:
a database processor for passing the keywords to a remote database server search database containing keywords in respect of said client.

37. A computer implemented program storage device readable by machine, tangibly embodying a program of instructions executable by the machine to perform method steps for allowing a first web surfer to locate at least one second web surfer having similar navigation and/or search strategies, said method steps comprising:
(a) receiving key words and/or URLs derived by parsing respective navigation and/or search strategies from all web surfers in communication with the web server in order to extract respective URLs of web sites visited by the web surfers and/or key words indicative of a navigation string,
(b) uploading said key words and URLs including a URL of each respective web surfer to a remote database, and
(c) downloading from the database similar key words and/or URLs to those of the first web surfer so as to locate said at least one second web surfer.

38. A computer implemented computer program product comprising a computer useable medium having computer readable program code embodied therein for allowing a first web surfer to locate at least one second web surfer having similar navigation and/or search strategies, said computer program product comprising:
computer readable program code for causing the computer to receive key words and/or URLs derived by parsing respective navigation and/or search strategies from all web surfers in communication with the web server in order to extract respective URLs of web sites visited by the web surfers and/or key words indicative of a navigation string,
computer readable program code for causing the computer to upload said key words and URLs including a URL of each respective web surfer to a remote database, and
computer readable program code for causing the computer to download from the database similar key words and/or URLs to those of the first web surfer so as to locate said at least one second web surfer.

39. A method for allowing a client machine connected via a communications network to a web server to effect a search using multiple search engines simultaneously, said method comprising the following steps all carried out by the web server:
(a) receiving from the client machine a search string as well as a list of search engines for effecting simultaneous searches,
(b) for each selected search engine, constructing an appropriate navigation pattern including URL and keywords, and
(c) feeding each navigation string to a respective search engine.

40. A web server allowing a client machine connected thereto via a communications network to effect a search using multiple search engines simultaneously, said web server comprising:
an input port for receiving from the client machine a search string as well as a list of search engines for effecting simultaneous searches,
a processor coupled to the input port for constructing an appropriate navigation pattern including URL and keywords each selected search engine, and
a communications module coupled to the processor for feeding each navigation string to a respective search engine.

41. A program storage device readable by machine, tangibly embodying a program of instructions executable by the machine to perform method steps for allowing a client machine connected via a communications network to a web server to effect a search using multiple search engines simultaneously, said method steps comprising:
(a) receiving from the client machine a search string as well as a list of search engines for effecting simultaneous searches,
(b) for each selected search engine, constructing an appropriate navigation pattern including URL and keywords, and
(c) feeding each navigation string to a respective search engine.

42. A computer program product comprising a computer useable medium having computer readable program code embodied therein for allowing a client machine connected via a communications network to a web server to effect a search using multiple search engines simultaneously, said computer program product comprising:
computer readable program code for causing the computer to receive from the client machine a search string as well as a list of search engines for effecting simultaneous searches,
computer readable program code for causing the computer to construct an appropriate navigation pattern including URL and keywords for each selected search engine, and
computer readable program code for causing the computer to feed each navigation string to a respective search engine.
